(19) United States
(12) Patent Application Publication
(10) Pub. No.: US 2006/0272164 A1
(43) Pub. Date: Dec. 7, 2006

(54) Spoon-like utensil

(76) Inventor: Joshua L. Waldman, Scarsdale, NY (US)

Correspondence Address: WOLF GREENFIELD & SACKS, PC, FEDERAL RESERVE PLAZA, 600 ATLANTIC AVENUE, BOSTON, MA, 02210-2206, US

(21) Appl. No.: 11/141,720

(22) Filed: Jun. 1, 2005

(51) Int. Cl. A47J 43/28

(52) U.S. Cl. 30/324; 30/325

(57) ABSTRACT

A spoon-like utensil having a pair of bowls stacked in spaced relationship one above the other and both bowls open at the top and sized to simultaneously fit within the mouth of the user. The lower of the two bowls is spaced with relation to the upper bowl so as to permit only liquid to enter the lower bowl while the upper bowl may receive both solid and liquid substances.

### BACKGROUND OF INVENTION

1. Field of Invention

This invention relates to eating utensils and more particularly to an improved spoon-like device.

2. Discussion of Related Art

Conventional spoons ordinarily include an ovid-shaped bowl and attached handle. Such spoons, when used while eating foods composed of a mixture of solid and liquid ingredients, do not always function satisfactorily in that they are incapable of providing a mixture of the ingredients in a proportion that suits the personal tastes of all. Frequently the spoon will not carry an adequate quantity of the liquid. Simply increasing the size of the bowl is not a satisfactory solution as the larger bowl will routinely gather more solid as well as liquid, and therefore, not achieve a greater proportion of liquid in the mixture. A very popular food that gives rise to this situation is breakfast cereal such as Grapenuts, Shredded Wheat, etc. Many other foods give rise to the same problem as well.

### SUMMARY OF INVENTION

In accordance with the present invention, the spoon includes a pair of bowls, one above the other, with the spacing of the bowls being such as to not readily admit solid foods into the lower bowl. In the preferred embodiment of the present invention, the two bowls are supported by a single handle structure, and the bowls are sufficiently small so that they simultaneously readily fit into the mouth. While the spacing of the bowls, particularly about their peripheries, is small enough to limit or substantially prevent the entry of solids into the lower bowl, the lower bowl will fill with liquid and is deep enough to accommodate a relatively large volume of liquid. The upper bowl readily accommodates a substantial quantity of solids.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view showing a double-bowled spoon constructed in accordance with the present invention;

FIG. 2 is a perspective view of the spoon of FIG. 1 disposed in a dish such as a cereal bowl and suggesting how the spoon functions to gather both solids (cereal) and liquid (milk) from the cereal bowl; and

FIG. 3 is an enlarged fragmentary cross-sectional view of the spoon and cereal bowl, circled at 3 in FIG. 2.

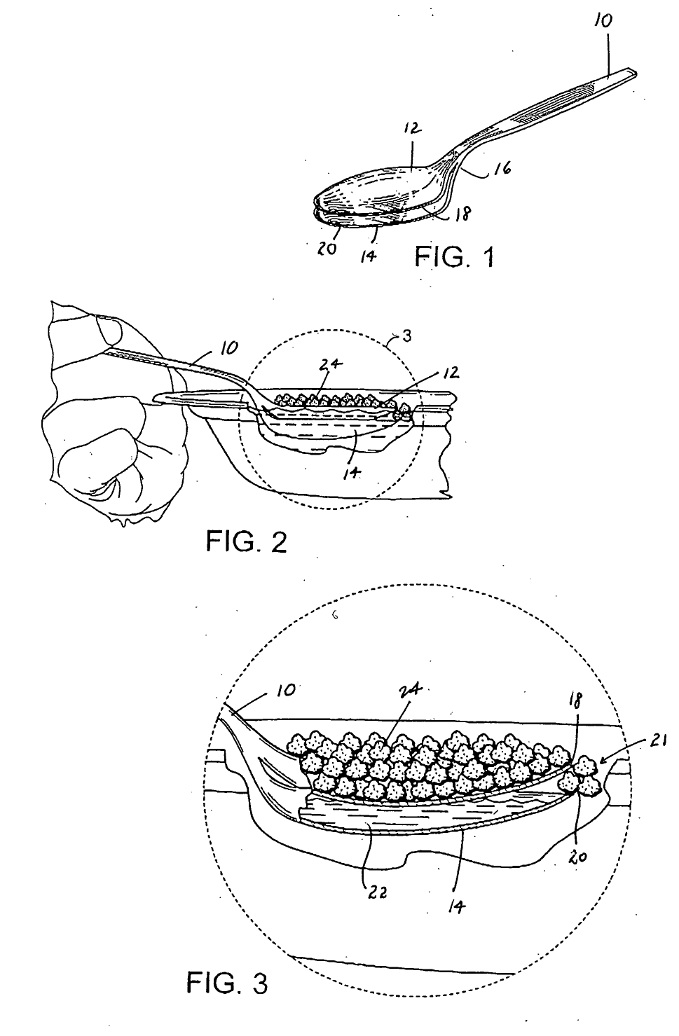

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The spoon of the illustrated embodiment of the present invention shown in the drawing includes a single handle 10 and a pair of bowls 12 and 14. Each spoon bowl 12 and 14 illustrated is generally ovid-shaped with the two bowls aligned vertically with one another and each is connected at its back end 16 to the handle. While the handle illustrated divides near the end adjacent the bowls 12 and 14, obviously, the handle may be connected in different ways and take different configurations. It is only necessary that the handle support the two bowls in the orientation desired, wherein the spacing between the bowl edges 18 and 20 is limited so as to prevent sizable solids from entering the lower bowl. For example, as shown in FIG. 3, the solids 21 representing those typically found in a cold breakfast cereal are unable to fit between the edges 18 and 20 and therefore cannot reach the main portion of the lower bowl 14. It will also be noted in FIG. 3 that the lower bowl 14 that does not carry any solids, nevertheless, does carry a substantial volume of liquid 22.

In use, the double-spoon utensil may be submerged in the dish to a depth sufficient to enable the upper spoon 12 to collect a substantial volume of the solid food 24 while the lower spoon 14 is submerged so that the liquid 22 may flow into the lower bowl 14 through the gap separating the rims 18 and 20 of the upper and lower bowls 12 and 14. When the spoon is withdrawn from the food in the serving dish, the upper spoon bowl will contain a substantial helping of solids while the lower bowl will contain significantly more of the liquid component than is contained in the upper bowl with the solids. In this manner, a more appealing mixture of the liquid and solid food components is collected by the spoon so as to add to the enjoyment of the eating experience.

It will be appreciated that to perform its intended function, the gap between the peripheral portion of the lower bowl and the nearest portion of the bottom surface of the upper bowl must be minimized. The two bowls need not be of the same size, depth or curvature. The bowls should be capable of simultaneously fitting into the mouth of the intended user. The spoon bowl 14 is imperforate so as to retain all of the liquid collected by it. While the upper spoon bowl 12 preferably is also imperforate, it may for certain applications of the invention have perforations. The spoon may be made of any material used in conventional eating utensils, including metal, wood or plastic, and it may be of any size that fits comfortably in the mouth of a person using it.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A spoon-like utensil comprising,
a pair of bowls disposed one above the other in closely spaced apart relationship with the bowls open upwardly in the generally same direction, the lower of said bowls being imperforate,
and a handle structure secured to the bowls and holding them in the same spacial relationship.

2. The utensil as described in claim 1 wherein the peripheral edge of the lower of the two bowls is so close to the upper bowl as to substantially preclude solid foods from entering the lower bowl when the bowls are submerged in a dish containing solid and liquid food components.

3. The utensil as described in claim 1 wherein the bowls can simultaneously hold liquid and the upper bowl is open to receive solids.

4. The utensil as described in claim 1 wherein the pair of bowls are sized so as to comfortably fit into a person's mouth.

5. The utensil as described in claim 4 wherein the bowls are sized to simultaneously fit within the mouth of a small child.

6. A spoon-like utensil sized for serving, preparing or eating food comprising,
a plurality of bowls disposed in a column and with their open faces all facing in generally the same direction,
a handle operatively connected to all of the bowls for serving, preparing and/or eating food with the utensil,
and means preventing at least one of the bowls from receiving solids and with all of the bowls capable of holding liquid.

7. The utensil as described in claim 6 wherein the bowls are sized so as to simultaneously comfortably fit into the mouth of an intended user.

8. The utensil as described in claim 6 wherein the bowls are sized to simultaneously fit within the mouth of a small child.

9. The utensil of claim 6 wherein the proximity of the edges of the bowl prevented from receiving solids being close to another of the bowls so as to prevent the bowl from receiving solids.

10. The utensil of claim 9 wherein only the topmost bowl is capable of receiving solids.
